(19) United States
(12) Patent Application Publication
(10) Pub. No.: US 2015/0062872 A1
(43) Pub. Date: Mar. 5, 2015

(54) LENS MODULE, LIGHT SOURCE ASSEMBLY AND BACKLIGHT ASSEMBLY HAVING THE LENS MODULE

(71) Applicant: Samsung Display Co., Ltd., Yongin-City (KR)

(72) Inventors: Hee Kwang SONG, Suwon-si (KR); Kang Woo LEE, Seoul (KR); Seok Hyun NAM, Seoul (KR); Ju Young YOON, Seoul (KR); Kwang Wook CHOI, Osan-si (KR)

(73) Assignee: Samsung Display Co., Ltd., Yongin-City (KR)

(21) Appl. No.: 14/249,231

(22) Filed: Apr. 9, 2014

(30) Foreign Application Priority Data
Sep. 2, 2013 (KR) 10-2013-0104825

(51) Int. Cl. F21V 5/04; F21V 9/08

(52) U.S. Cl. CPC F21V 5/045; F21V 9/08
USPC 362/97.1; 362/311.06; 362/231; 362/335

(57) ABSTRACT

Provided are a light source assembly and a backlight assembly including a lens module. The light source assembly includes: a light source module capable of emitting light and a lens module positioned on the light source module. The lens module includes a light collecting lens collecting the light emitted from the light source module, and a diffusion lens positioned on the light collecting lens, and including an inner curved surface in which light from the light collecting lens is incident and an outer curved surface where the light incident on the inner curved surface exits the diffusion lens, and the light emitted from the light source module forms a light collecting region on the inner curved surface by passing through the light collecting lens.

### CROSS-REFERENCE TO RELATED APPLICATION

This application claims priority, under 35 U.S.C. 119, from Korean Patent Application No. 10-2013-0104825 filed on Sep. 2, 2013 in the Korean Intellectual Property Office, the content of which is herein incorporated by reference in its entirety.

### TECHNICAL FIELD

The inventive concept disclosed herein relates to a lens module, a light source assembly, and a backlight assembly having the lens module.

### BACKGROUND

In general, a liquid crystal display has advantages such as thinness, light weight, and low power consumption compared to other types of displays in the market. As a result, liquid crystal displays are used in various applications such as monitors, notebooks, cellular phones, large televisions, and the like. A liquid crystal display includes a liquid crystal display panel displaying an image by using light transmittance of a liquid crystal, and a backlight assembly placed below the liquid crystal display panel and providing light to the liquid crystal display panel.

The backlight assembly includes light sources generating light required to display the image on the liquid crystal display panel. For example, the light sources may be a cold cathode fluorescent lamp (CCFL), an external electrode fluorescent lamp (EEFL), a flat fluorescent lamp (FFL), or a light emitting diode (LED).

In recent years, an LED is often used as the light source because it has low power consumption and is environmentally friendly. An LED module may include a red LED chip, a green LED chip, and a blue LED chip. The LED module may output white light by mixing the light emanating from a plurality of LED chips.

The LED chips have a light distribution of a point light source type, and the point light source type light distribution is changed to a plane light source type light distribution to be emitted to a predetermined region by a dedicated lens.

### SUMMARY

The inventive concept presented herein provides a lens module, a light source assembly, and a backlight assembly that can achieve light distribution with improved uniformity.

In another aspect, the inventive concept presented herein provides a lens module, a light source assembly, and a backlight assembly capable of minimizing a color spread phenomenon by improving light mixture.

According to embodiments of the inventive concept, at least the following effects are obtained.

A lens module capable of improving light luminance uniformity and color uniformity can be provided.

A light source assembly and a backlight assembly that have the improved light luminance uniformity and color uniformity are provided.

The effects of the embodiments are not limited to the aforementioned effects, and other effects that are not explicitly mentioned above will be apparently understood by the person skilled in the art from the recitations of the claims.

According to an aspect of the inventive concept, there is provided a light source assembly that includes: a light source module capable of emitting light; and a lens module positioned on the light source module, wherein the lens module includes a light collecting lens configured to collect the light emitted from the light source module; and a diffusion lens positioned on the light collecting lens, and including an inner curved surface on which light from the light collecting lens is incident and an outer curved surface through which the light incident on the inner curved surface exits the diffusion lens, and wherein the light emitted from the light source module forms a light collecting region on the inner curved surface by passing through the light collecting lens.

According to another aspect of the inventive concept, there is provided a lens module collecting and diffusing light emitted from a light source module. The lens module includes: a light collecting lens collecting the light emitted from the light source module; and a diffusion lens positioned on the light collecting lens, and including an inner curved surface that is configured to receive from light the light collecting lens and an outer curved surface through which the light exits the diffusion lens, wherein there is a light collecting region on the inner curved surface where light from the light collecting lens is concentrated.

According to yet another aspect of the inventive concept, there is provided a backlight assembly. The backlight assembly includes: a circuit substrate; at least one light source assembly positioned on the circuit substrate; and a receiving member receiving the circuit substrate, wherein the light source assembly includes: a light source module capable of emitting light; and a lens module positioned on the light source module, the lens module including: a light collecting lens collecting the light emitted from the light source module; and a diffusion lens positioned on the light collecting lens, and including an inner curved surface in which light exiting the light collecting lens is incident and an outer curved surface where the light incident on the inner curved surface exits the diffusion lens, and the light emitted from the light source module forms a light collecting region on the inner curved surface by passing through the light collecting lens.

### BRIEF DESCRIPTION OF THE DRAWINGS

The above and other features and advantages of the inventive concept will become more apparent by describing in detail embodiments thereof with reference to the attached drawings, in which:

FIG. 1 is an exploded perspective view of a backlight assembly according to an embodiment;

FIGS. 2 and 3 are cross-sectional views of a light source assembly taken along line P1-P2 of FIG. 1;

FIG. 4 is a perspective view illustrating a diffusion lens in a lens module illustrated in FIG. 3;

FIG. 5 is a plan view of the diffusion lens illustrated in FIG. 4;

FIG. 6 is a cross-sectional view of the diffusion lens taken along line I1-I2 of FIG. 5;

FIG. 7 is a cross-sectional view of the diffusion lens taken along line I3-I4 of FIG. 5;

FIG. 8 is a cross-sectional view illustrating a modified embodiment of the diffusion lens illustrated in FIG. 7;

FIG. 9 is a cross-sectional view illustrating another modified embodiment of the diffusion lens illustrated in FIG. 7;

FIG. 10 is a cross-sectional view illustrating a light collecting lens according to an embodiment;

FIG. 11 is a plan view of the light collecting lens illustrated in FIG. 10;

FIG. 12 is a cross-sectional view illustrating a modified embodiment of the light collecting lens illustrated in FIG. 10;

FIG. 13 is a cross-sectional view illustrating another modified embodiment of the light collecting lens illustrated in FIG. 10;

FIG. 14 is a cross-sectional view illustrating a light source module according to an embodiment;

FIG. 15 is a cross-sectional view illustrating a modified embodiment of the light source module illustrated in FIG. 14; and

FIG. 16 is a cross-sectional view illustrating another modified embodiment of the light source module illustrated in FIG. 14.

### DETAILED DESCRIPTION OF THE EMBODIMENTS

Advantages and features of the present invention and methods of accomplishing the same may be understood more readily by reference to the following detailed description of embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing the particular embodiments that are disclosed and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, embodiments of the inventive concept will be described with reference to the drawings.

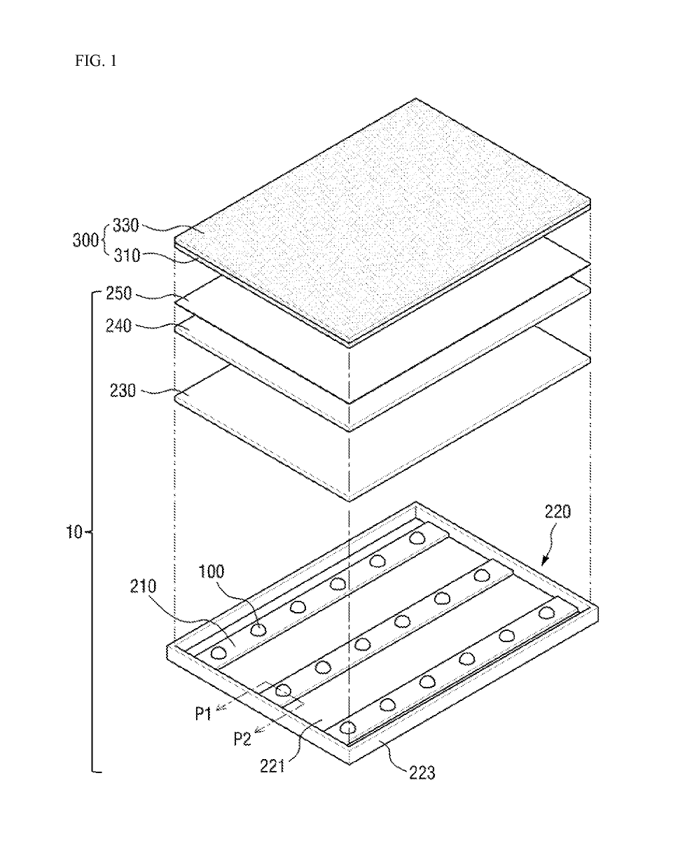

FIG. 1 is an exploded perspective view of a backlight assembly according to an embodiment.

Referring to FIG. 1, a backlight assembly 10 according to an embodiment may include a circuit substrate 210, a plurality of light source assemblies 100, and a receiving container 220.

The circuit substrate 210 is a thin substrate on which wires (not shown) are formed. The circuit substrate 210 may include, for example, a printed circuit board (PCB) or a metal coating printed circuit board (MCPCB) in which a printed circuit board is coated with metal having high thermal conductivity. Further, the circuit substrate 210 may include a flexible printed circuit board (FPCB) having flexibility as necessary. Power applied from the outside in order to drive a light source in the light source assembly 100 may be transmitted to the light source assemblies 100 through the wires.

The light source assemblies 100 are placed on the circuit substrate 210 to generate light. The light source assemblies 100 may be fixed onto the circuit substrate 210 by combining terminals (not shown) and the circuit substrate 210. The light source assemblies 100 will be described below in detail.

The receiving container 220 may include a bottom part 221 and a side wall 223 extending from an edge of the bottom part 221 and forming a receiving space in order to receive the circuit substrate 210 joined with the light source assembly 100. The circuit substrate 210 may be placed on the bottom part 221 of the receiving container 220. The receiving container 220, in one embodiment, may be made of metal that has high rigidity and low deformability, but is not limited thereto and may be made of plastic, or the like.

The backlight assembly 10 may further include a light guiding member 230 that is placed above the light source assemblies 100. The light guiding member 230 may be spaced apart from the light source assemblies 100 by a predetermined gap. The light guiding member 430 may be made of poly methyl methacrylate (PMMA), as one example, but is not limited thereto. The backlight assembly 10 may include the light guiding member 230 as necessary and the light guiding member 230 may be omitted.

The backlight assembly 10 may further include a diffusion plate 240 placed above the light guiding member 230. The diffusion plate 240 may be spaced apart from the light guiding member 230 by a predetermined minimum gap. The diffusion plate 240 diffuses light emitted from the light guiding member 230 to improve luminance uniformity of light. The diffusion plate 240 has a plate shape having a predetermined thickness. The diffusion plate 240 may be made of, for example, poly methyl methacrylate (PMMA) and may include a diffusion agent for diffusing light inside. Further, although not illustrated in the figure, the diffusion plate 240 may further include a plurality of diffusion patterns formed on at least one surface to more uniformly diffuse the supplied light.

The backlight assembly 10 may further include an optical sheet 250 having various functions depending on a required luminance characteristic. For example, the optical sheet 250 may be a prism sheet and collect light emitted from the diffusion plate 240. The prism sheet may include vertical and horizontal prism sheets that collect light in vertical and horizontal direction, respectively, but the inventive concept is not limited thereto.

The aforementioned backlight assembly 10 supplies light to a display panel 300, and as a result, the display panel 300 may display an image provided to the outside. The display panel 300 may include a first substrate 310 and a second substrate 330 that are bonded to each other, and a liquid crystal layer (not illustrated) interposed between two substrates. Herein, although not illustrated in the figure, in general, a plurality of gate lines and data lines cross each other, and as a result, a pixel is defined on an inner surface of the first substrate 310 (herein referred to as a “lower substrate”), a thin-film transistor substrate, or an array substrate, a thin film transistor (TFT) may be provided for each cross point, and connected with a transparent pixel electrode formed in each pixel to correspond to each other one to one. For example, color filters of red (R), green (G), and blue (B) colors corresponding to each pixel, and a gate line and a data line positioned among the color filters, and a black matrix positioned among the color filters and covering the gate line and the data line, and the thin film transistor or the like may be provided on an inner surface of the second substrate 300 called an upper substrate or a color filter substrate. Further, a transparent common electrode covering the color filters of the red (R), green (G), and blue (B) colors, and the black matrix may be provided on the second substrate 330.

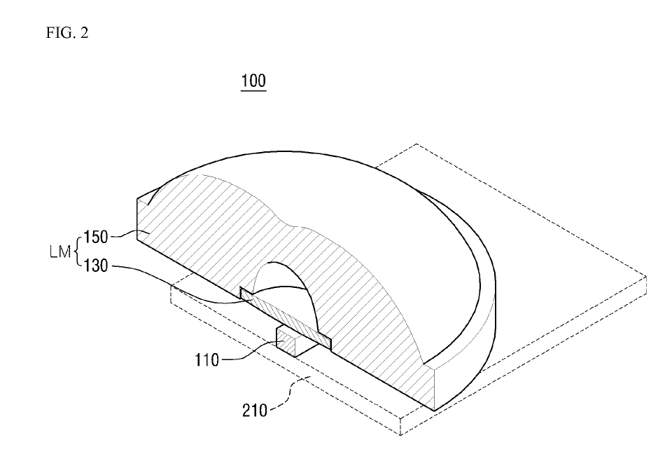

FIGS. 2 and 3 are cross-sectional views of a light source assembly according to an embodiment and in more detail, are cross-sectional views of the light source assembly taken along line P1-P2 of FIG. 1.

Referring to FIGS. 2 and 3, the light source assembly 100 according to the embodiment of the present invention may include a light source module 110 and a lens module LM.

The light source module 110 may include point light sources generating different single-color lights that may be combined to generate white light, and the LED may be used as a point light source. For example, the point light sources may include a red LED generating red light, a blue LED generating blue light, and a green LED generating green light, and the red light, the blue light, and the green light are mixed with each other to generate white light. Alternatively, the light source module 110 may include a white LED generating white light.

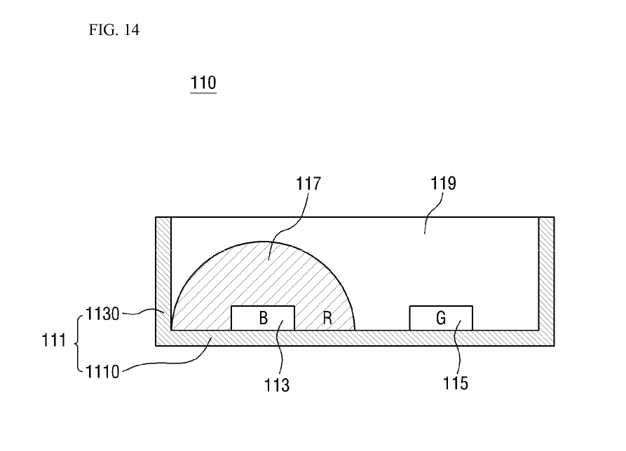

Alternatively, the light source module 110 may include a resin including the green LED, the blue LED, and a red fluorescent substance. In this case, the light source module 110 may output the white light by using the light provided from the plurality of LEDs, and the red fluorescent substance absorbs blue light to display a red color. The light source module 110 including the fluorescent substance will be described below in detail with reference to FIGS. 14 to 16.

The lens module LM may be placed on the light source module 110 and include a light collecting lens 130 and a diffusion lens 150.

The light collecting lens 130, which is an optical member that collects light emitted from the light source module 110, may include a first lens surface 130a positioned between the light source module 110 and a second lens surface 130b. In addition, the light emitted from the light source module 110 is refracted on the first lens surface 130a and refracted on the second lens surface 130b once more when passing through an inner part of the light collecting lens 130. The light exiting the light collecting lens 130 is collected to be provided to the diffusion lens 150.

The diffusion lens 150 as an optical member that diffuses light collected by transmitting the light collecting lens 130 to emit the diffused light to the outside may have an inner curved surface 151 in which the light collected by the light collecting lens 130 is incident and an outer curved surface 157 contacting the outside. The light collected by the light collecting lens 130 is once refracted on the inner curved surface 151 through an air layer and refracted on the outer curved surface 157 once more through an inner part of the diffusion lens 150 to be diffused and emitted to the outside.

That is, the light emitted from the light source module 110 is collected through the light collecting lens 130 and the light collected through the light collecting lens 130 is diffused to the outside through the diffusion lens 150. Herein, the light collected through the light collecting lens 130 forms a light collecting region on the inner curved surface 151 of the diffusion lens 150.

The light collecting region refers to a part of the inner curved surface 151 in which the light collected through the light collecting lens 130 is concentrated. The light collecting region may be a point or have the same shape as a part of the inner curved surface 151. In other words, the light collecting region as a part of the inner curved surface 151 may be defined as where the light collected through the light collecting lens 130 is incident. Further, when the light collecting region is a point, the light collecting region may be defined as a focal point of the light collecting lens 130 and in this case, the focal point of the light collecting lens 130 would be positioned on the inner curved surface 151.

The light source assembly 100 according to one embodiment has the advantage of light being collected through the light collecting lens 130 of the lens module LM and thereafter, being diffused through the diffusion lens 150 to improve overall uniformity of light supplied to the outside. In particular, when the light source module 110 includes point light sources generating different single-colored light beams, the light source module 110 has advantages of improved color mixing level of light provided to the outside and reduced color shading. This benefit stems from the different single-color light beams being collected through the light collecting lens 130 and then being diffused through the diffusion lens 150.

In one embodiment, the light source assembly 100 is applied to the backlight assembly 10 of FIG. 1, but this is just one example. In some embodiments, the light source assembly 100 of this disclosure may be applied to even a general illumination device field in addition to the backlight assembly 10 of FIG. 1.

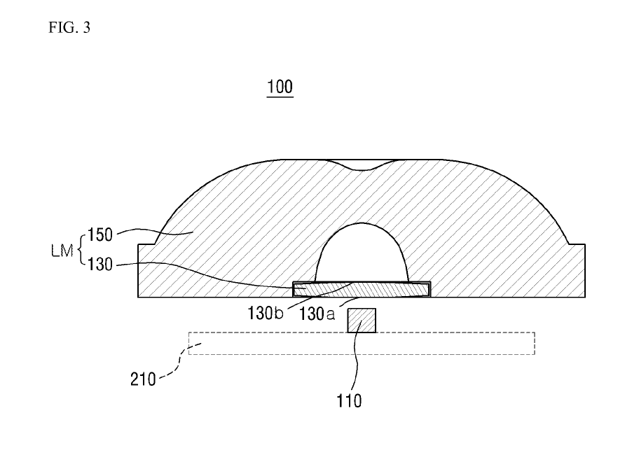

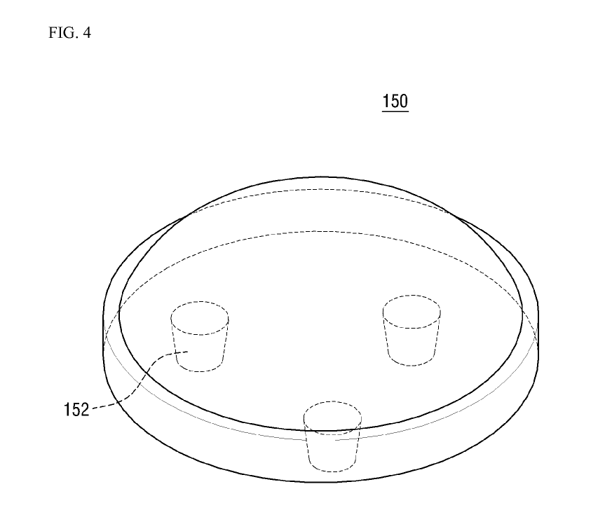

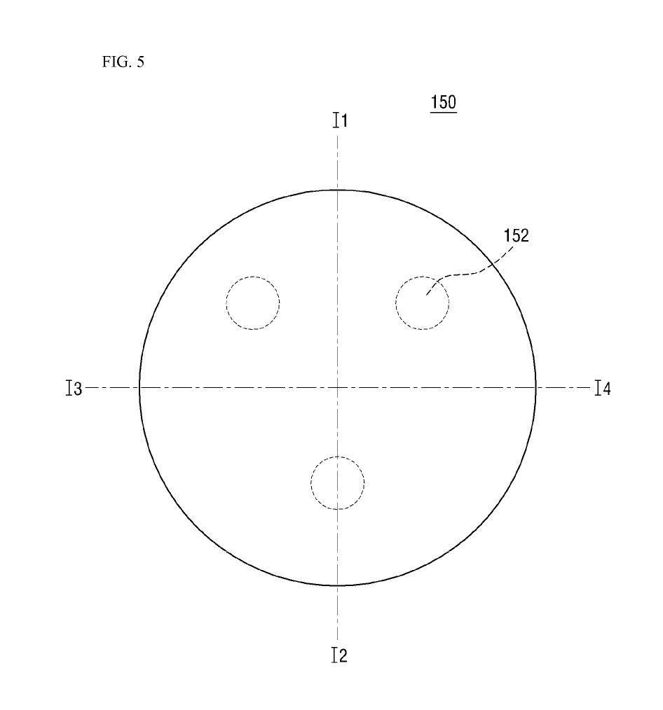

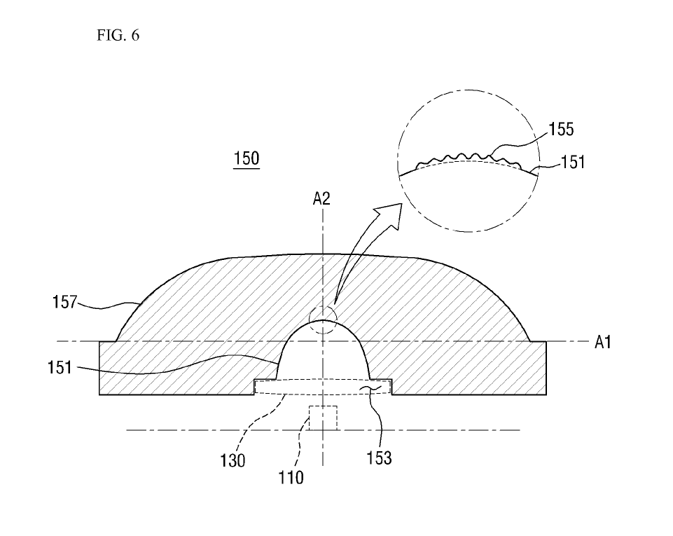

FIGS. 4 and 5 are a perspective view and a plan view illustrating a diffusion lens in the lens module illustrated in FIG. 3. FIG. 6 is a cross-sectional view of the diffusion lens taken along line I1-I2 of FIG. 5. FIG. 7 is a cross-sectional view of the diffusion lens taken along line I3-I4 of FIG. 5.

Referring to FIGS. 4 to 6, the diffusion lens 150 of the present invention may include a plurality of supports 152 formed on the bottom thereof. The supports 152 are seated on the circuit substrate 210 of FIGS. 1 to 3 to assist the lens module LM of FIG. 3 to be seated at an accurate location. The supports 152 may extend from the bottom of the diffusion lens 150 as illustrated in the figure and at least three supports 152 are formed to assist the lens module LM to be seated at the accurate location. When a separate groove is formed on the circuit substrate 210 of FIGS. 1 to 3, the supports 152 may be joined to the grooves of the circuit substrate 210 of FIGS. 1 to 3.

The supports 152 may be formed integrally with the diffusion lens 150 or formed as separate components to be joined with the diffusion lens 150.

However, the above embodiments are just examples, and the shape and number of the supports 152 may be appropriately changed as necessary.

Referring to FIG. 7, the diffusion lens 150 may have an inner curved surface 151 and an outer curved surface 157 having an oval surface shape in order to more widely diffuse the light generated from the point light source. In general, an oval is defined as a locus of points in which a sum of distances from two apexes is constant and in this case, each of the two apexes are called a focus. Further, in the oval, an axis linking two apexes by a straight line is a long axis and an axis that is perpendicular to the long axis while passing through the center of the oval is a short axis.

Therefore, in an oval, the length of the long axis is larger than the length of the short axis. Meanwhile, an oval surface is formed while rotating the long axis or the short axis of the oval as a rotational axis.

The inner curved surface 151 and the outer curved surface 157 of the diffusion lens 150 according to the present invention may have an oval surface shape in which the long axes are formed to be perpendicular to each other. For example, when the long axis of the inner curved surface 151 is formed in a vertical plane direction, the long axis of the outer curved surface 157 may be formed in a horizontal direction. As such, when the long axes of the inner curved surface 151 and the outer curved surface 157 are formed to be perpendicular to each other, the thickness of the diffusion lens 150, that is, a distance between the inner curved surface 151 and the outer curved surface 157 is changed depending on the location. Therefore, a path of the light passing through the diffusion lens 150 differs according to the exact location on the lens, due to a difference in thickness of the diffusion lens 150. As a result, the emitted light is further diffused to be emitted.

In one embodiment, the inner curved surface 151 has the shape of a first oval surface 112 in which a long axis A1 is formed in the first vertical plane direction and the outer curved surface 157 may have a shape of a second oval surface 122 in which a long axis A2 is formed in the horizontal plane direction.

A light scattering pattern 155 may be formed on the inner curved surface 151 and the light scattering pattern 155 may have predetermined roughness. The light scattering pattern 155 may be formed throughout the inner curved surface 151 and formed at only a portion corresponding to the aforementioned light collecting region in the description of FIG. 3 in the inner curved surface 151.

The light scattering pattern 155 is formed through surface processing of the inner curved surface 151 to be formed integrally with the diffusion lens 150 as illustrated in FIG. 6. The light scattering pattern 155 may be formed in an engraving pattern as illustrated in FIG. 7, but is not limited thereto and a part or all of the light scattering patterns may be configured by an embossing pattern. Alternatively, a pattern is formed in a separate member (for example, an optical film), or the like and the pattern is attached onto the inner curved surface 151 to form the light scattering pattern 155.

As the light scattering pattern 155 is formed on the inner curved surface 151, the light collected by the light collecting lens 130 of FIG. 3 is scattered by the light scattering pattern 155 and then diffused to exit the diffusion lens 150. As a result, the uniformity of the light provided to the outside may be further improved. Further, when light which is fully reflected on the outer curved surface 157 through the inner part of the diffusion lens 150 is again reflected through the inner curved surface 151, the corresponding reflected light may be scattered through the light scattering pattern 155 again, and as a result, more uniform light may be provided to the outside. Moreover, when the light source module 110 of FIG. 3 emits two or more different single light beams, the color mixing level and the color uniformity may be further improved. In particular, when the light collecting region has the shape of the point, in other words, when the focus of the light collecting lens 130 is positioned on the inner curved surface 151, the aforementioned light uniformity improvement effect and color uniformity improvement effect may be maximized.

The aforementioned diffusion lens 150 according to the present invention may be made of optical glass or an optical synthetic resin. In this case, as the optical glass, BK7 or SK5 may be used and as the optical synthetic resin, poly methyl methacrylate (PMMA) or polycarbonate (PC) may be used, but the present invention is not limited thereto. As shown in FIG. 7, there is a space between the light collecting lens 130 and the inner curved surface 151 of the diffusion lens 150. This space may be filled with air.

A lens joining groove 153 may be formed in the inner part of the diffusion lens 150. In particular, the lens joining groove 153 may be formed where both ends of the inner curved surface 151 are positioned. The lens joining groove 153 to which the light collecting lens 130 is joined may have a shape corresponding to the shape of the light collecting lens 130. That is, the light collecting lens 130 may be inserted into and joined to the lens joining groove 153 of the diffusion lens 150 such that the diffusion lens 150 and the light collecting lens 130 may form a lens assembly (herein also referred to as the lens module LM). Therefore, a process of manufacturing the light source module 110, a process of seating the light source module 110 on the circuit substrate 210, and a process of manufacturing the lens module LM are performed independently of each other, improving manufacturing process efficiency. Moreover, as a separate component for supporting the light collecting lens 130 is not required in the above configurations, the overall structure of the light source assembly may be simplified and the dimensions of the light source assembly may be decreased.

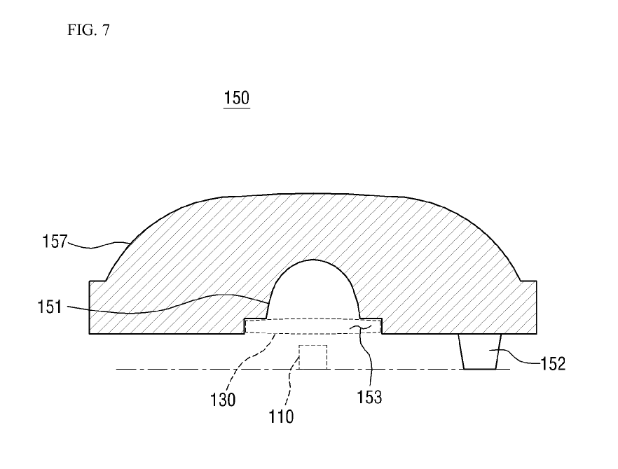

FIG. 8 is a cross-sectional view illustrating a modified embodiment of the diffusion lens illustrated in FIG. 7.

Referring to FIG. 8, a diffusion lens 150-1 according to the embodiment may further include a dent portion 158 formed on the outer curved surface 157. That is, the diffusion lens 150-1 is partially different from the diffusion lens of FIG. 7 in that the diffusion lens 150-1 according to the embodiment of FIG. 8 further includes the dent portion 158. The embodiments of FIGS. 7 and 8 may be substantially similar in other aspects.

The dent portion 158 may be formed in a part corresponding to the light source module 110. That is, the dent portion 158 may have a concave shape toward the light source module 110 as illustrated in FIG. 8, and light that is incident from the bottom may be diffused to have a large emission angle. As a result, a hot spot is decreased, and as a result, luminance distribution uniformity and color uniformity of light may be further improved.

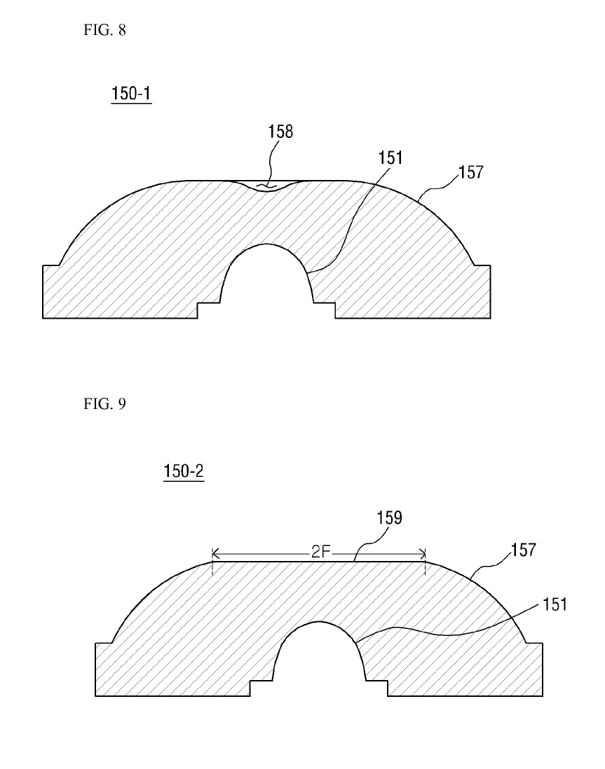

FIG. 9 is a cross-sectional view illustrating another embodiment of the diffusion lens illustrated in FIG. 7.

Referring to FIG. 9, a diffusion lens 150-2 may further include a flat portion 159 formed on the outer curved surface 157. That is, the diffusion lens 150-2 according to the embodiment of FIG. 9 is partially different from the diffusion lens of FIG. 7 in that the diffusion lens 150-2 further includes the flat portion 159. The embodiments of FIGS. 7 and 9 may be substantially similar in other aspects.

The flat portion 159 may be formed, at least in a part, to correspond to the light source module 110 and a plane shape thereof may have a circular shape having a predetermined radius F. The flat portion 159 increases the probability that the light incident from the bottom will be reflected, thereby diffusing light more uniformly. As a result, the luminance distribution uniformity and the color uniformity of the light may be improved.

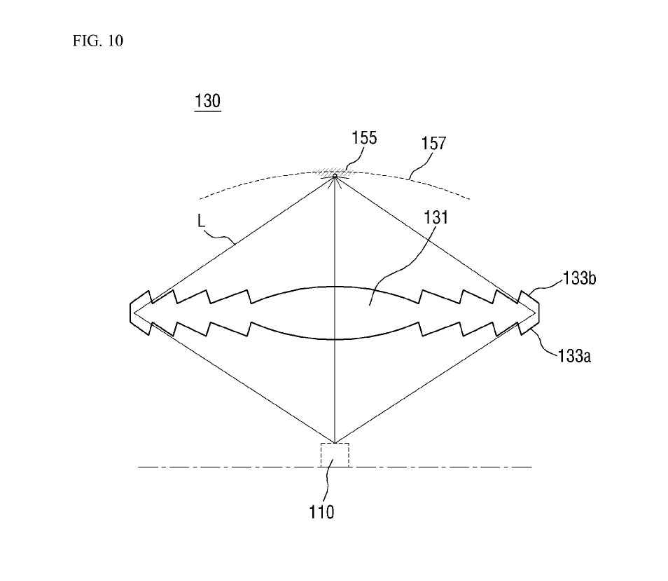

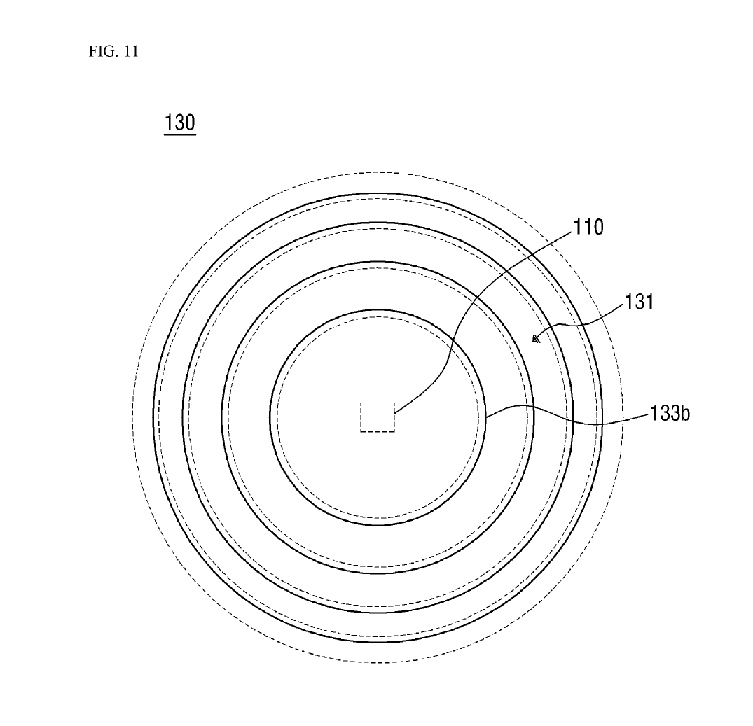

FIG. 10 is a cross-sectional view illustrating a light collecting lens 130 according to an embodiment. FIG. 11 is a plan view of the light collecting lens 130 illustrated in FIG. 10.

Referring to FIGS. 10 and 11, the light collecting lens 130 according to the embodiment may be configured to incorporate a Fresnel lens 131. The Fresnel lens 131 may include a first Fresnel lens surface 133a facing the light source module 110 and a second Fresnel lens surface 133b facing the first Fresnel lens surface 133a, and each of the Fresnel lens surfaces 133a and 133b may include concentric patterns as illustrated in FIG. 11. That is, the first lens surface 130a of FIG. 3 of the light collecting lens 130 may be configured by the first Fresnel lens surface 133a and the second lens surface 130b of FIG. 3 may be configured by the second Fresnel lens surface 133b.

The shapes of the first Fresnel lens surface 133a and the second Fresnel lens surfaces 133b may be symmetric to each other in the horizontal direction as illustrated in FIG. 10. However, this is just one embodiment and the shapes may be asymmetric in other embodiments.

The light collecting lens 130 collects the light radially emitted from the light source module 110 and provides the collected light to the inner curved surface 157 of the diffusion lens as described above. When the light collecting lens 130 is formed by the Fresnel lens 131, the size and the thickness of the lens 130 may be reduced and a focal distance may be shortened while a light collecting function is executed. As a result, the thicknesses of the lens module LM and the light source assembly 100 of FIG. 1 may be reduced.

Meanwhile, in FIG. 10, the Fresnel lens surfaces 133a and 133b are formed on both surfaces of the Fresnel lens 131, but this is just one example and other embodiments may include just one of the Fresnel lens surfaces 133a and 133b. More specifically, the Fresnel lens 131 may include only the first Fresnel lens surface 133a or only the second Fresnel lens surface 133b.

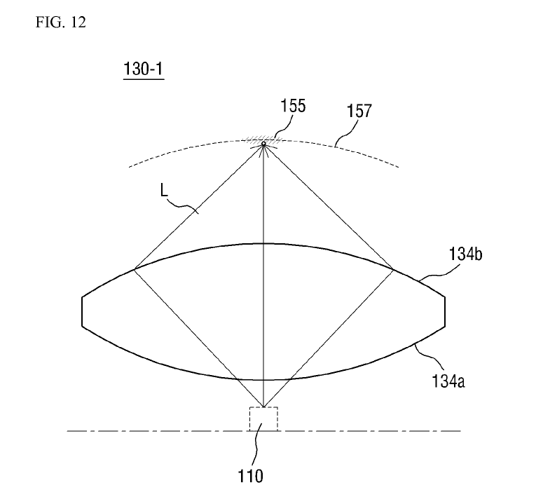

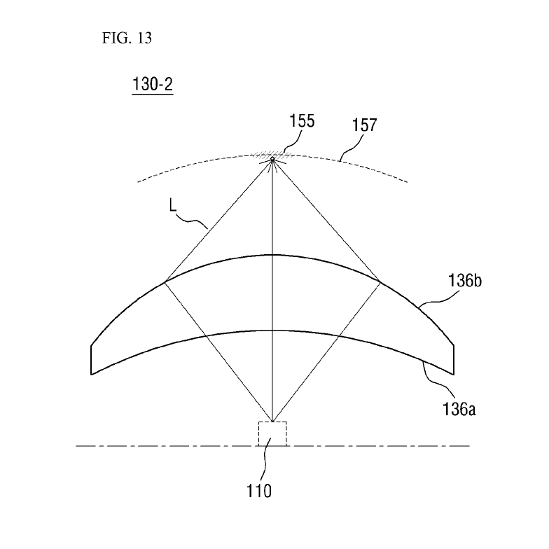

FIGS. 12 and 13 illustrate a modified embodiment of the light collecting lens illustrated in FIG. 10.

Referring to FIG. 12, both surfaces of a light collecting lens 130-1 according to the embodiment may have a shape of a convex lens. That is, the first lens surface 134a facing the light source module 110 may have a convex shape projecting toward the light source module 110 and the second lens surface 134b facing the first lens surface 134a may have a convex shape projecting toward the inner curved surface 157.

Referring to FIG. 13, one surface of a light collecting lens 130-2 according to the embodiment may have the shape of a concave lens and the other surface may have the shape of the convex lens. That is, the first lens surface 136a facing the light source module 110 may have a concave shape such that the center of the surface 136a is farther away from the light source module 110 than the edges, (thereby forming a curve similar to an inner curved surface 157). The second lens surface 136b facing the first lens surface 136a may have the convex shape projecting away from the light source module 110, toward the inner curved surface 157.

However, the aforementioned arrangement is just one example and the shape of the light collecting lens 130 may be changed to various shapes to implement the light collecting function.

FIG. 14 is a cross-sectional view illustrating a light source module according to an embodiment.

Referring to FIG. 14, the light source module 110 may include a receiving container 111, a first light source 113, a second light source 115, a first resin 117, and a second resin 119.

The receiving container 111 may include a bottom surface 1110 and a side wall 1130, and in more detail, the receiving container 111 may have a rectangular parallelepiped shape including the bottom surface 1110 and four side walls 1130. The receiving container 111 may be made of a mold resin and formed by a injection molding method, but that is not a limitation of the present disclosure.

A first light source 113 may be placed on the bottom surface 1110. The first light source 113 may generate light of a first color and the first color may be a blue color. For example, the first light source 113 may be a blue LED and although not illustrated in the figure, the first light source 113 may have two or more blue LEDs.

The second light source 115 may be placed on the bottom surface 1110 may be placed somewhere other than where the first light source 113 is placed. The second light source 115 may generate light of a second color and the second color may be a green color. For example, the second light source 115 may be a green LED and although not illustrated in the figure, the second light source 115 may have two or more green LEDs.

Although not explicitly illustrated, an electrode unit for driving the first and second light sources 113 and 115 may be provided in the receiving container 111. The first and second light sources 113 and 115 may be connected to the electrode unit formed in the receiving container 111 by a connection line.

The first resin 117 is formed on the first light source 113 to cover the top and the side of the first light source 113. In particular, in the embodiment, the first resin 117 may include a fluorescent substances having a third color and the third color may be a red color. The red fluorescent substance may be a nitride or oxynitride based fluorescent substance.

The first resin may include at least one of methyl based silicon, phenyl based silicon, and epoxy. As a method of forming the first resin 340, a method may be used, which mixes the red fluorescent substance with the methyl based silicon, the phenyl based silicon, and the epoxy by using a mixer (not illustrated), degases the mixed resin by using a degaser (not illustrated), and thereafter, sprays the degassed resin onto the first light source 320 by using a dispenser (not illustrated).

The light source module 110 may generate mixed light by using the first light source 113, the second light source 115, and the fluorescent substance of the first resin 117, and output the mixed light to the lens module LM of FIG. 3. In detail, the first light source 113 may generate blue light and the red fluorescent substance absorbs the blue light to generate red light. The blue light and the red light are mixed on the first resin to generate magenta light. The second light source 115 may generate green light, and the magenta light generated on the first resin 117 is mixed with the green light generated in the second light source 115 to generate the mixed light.

Ideally, the mixed light may be white light, but actually, when light is not uniformly mixed, there is a possibility that the color shading will occur. According to the present disclosure, since the light generated from the light source module 110 is collected and then diffused and emitted to the outside by using the lens module LM of FIG. 3, color shading may be prevented and color uniformity may improve.

The second resin 119 is formed on the first resin 117 and the second light source 115 to cover the top of the first resin 117, and cover the top and the side of the second light source 115.

The second resin 119 may include at least one of the methyl based silicon, the phenyl based silicon, and the epoxy. As a method of forming the second resin 119, a method may be used, which sprays the methyl based silicon, the phenyl based silicon, and the epoxy onto the first resin 117 and the second light source 115 by using the dispenser.

A refractive index of the first resin 117 may be larger than that of the second resin 119.

When the refractive index of the first resin 117 is smaller than that of the second resin 119, a component of the light from the second light source 115 may propagate toward the first resin 117 through the second resin 119 and also through the first resin 117. For example, where the second light source 115 is a green LED chip, the green light would pass through the second resin 119 and the first resin 117. Accordingly, the light from the second light source 115 may be absorbed by the fluorescent substance of the first resin 117, reducing the efficiency of the light source module 110.

On the contrary, when the refractive index of the first resin 117 is larger than that of the second resin 119, light that moves toward the first resin 117 through the second resin 119 may not be able to pass through the first resin 117 easily. For example, where the second light source 115 is a green LED chip, the green light would pass through the second resin 119 but not as easily through the first resin 117. Accordingly, less of the light from the second light source 115 will be absorbed by the fluorescent substance of the first resin 117, increasing the efficiency of the light source module 110. For example, some of the green light emitted from the second light source 115 may be reflected on a boundary surface of the first resin 117 and the second resin 119 to thereby prevent the light from moving to the inside of the first resin 117.

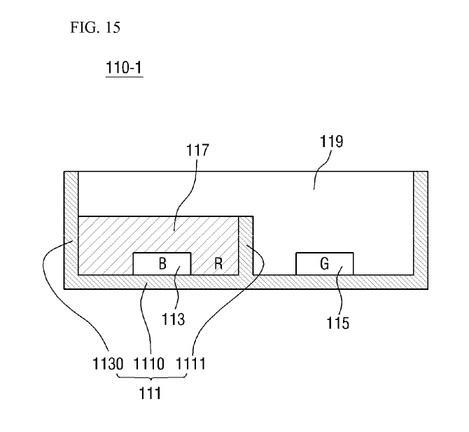

FIG. 15 is a cross-sectional view illustrating a modified embodiment of the light source module illustrated in FIG. 14. Referring to FIG. 15, a light source module 110-1 according to the embodiment is partially different from the light source module 110 of FIG. 13 in that the light source module 110-1 further includes a protrusion portion 1111 formed on the bottom surface 1110.

The protrusion portion 1111 may be positioned between the first light source 113 and the second light source 115, and the second light source 115 and the first resin 117 may be spatially separated from each other due to the protrusion portion 1111.

Since the red fluorescent substance absorbs a lot of green light in addition to the blue light, the efficiency of the light source module may be reduced. Accordingly, when the red fluorescent substance and the light source emitting the green light are spatially separated from each other, there may be an improvement to the efficiency of the light source module.

The presence of the protrusion portion 1111 placed between the first light source 113 and the second light source 115 decreases the contact between the green light emitted from the second light source 115 and the fluorescent substance of the first resin 117 in the light source module 110-1. Hence, the efficiency of the light source module 110-1 is increased.

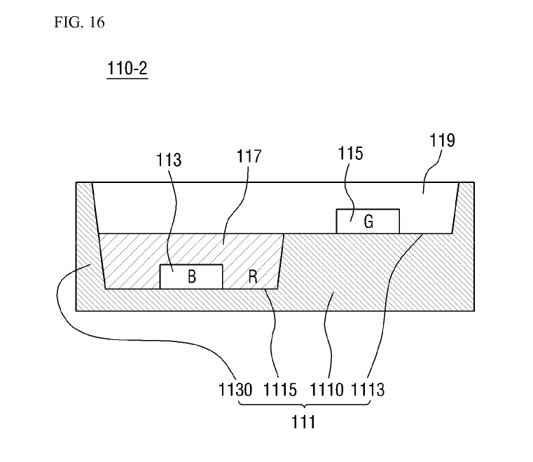

FIG. 16 is a cross-sectional view illustrating another modified embodiment of the light source module illustrated in FIG. 14.

Referring to FIG. 16, the light source module 110-1 according to the embodiment is partially different from the light source module 110 of FIG. 10 illustrated in FIG. 14 in that the light source module 110-1 has a first bottom surface 1113 and a second bottom surface 1115 which have different levels. In the embodiment of the light source module 110-1 that is shown, the first bottom surface 1113 may be positioned, at least in part, relatively lower than the second bottom surface 1115.

The first light source 113 may be positioned on the first bottom surface 1113 and the second light source 115 may be positioned on the second bottom surface 1115. In addition, the first resin 117 may cover the top and the side of the first light source 113 and the second resin 119 may cover the top and the side of the second light source 115 and the first resin 117. The first light source 113, the second light source 115, the first resin 117, and the second resin 119 in the light source module 110-2 are substantially the same as in the embodiment of FIG. 14. Therefore, a detailed description of those parts will not be repeated.

In a light source module 110-2 according to the embodiment, since the first light source 113 and the second light source 115 are placed on the bottom surfaces 1113 and 1115 positioned at different levels, the second light source 115 and the first resin 117 may be spatially separated from each other. As a result, the green light emitted from the second light source 115 contacts the fluorescent substance of the first resin 117 at reduced frequency, increasing the efficiency of the light source module 110-2.

According to the present disclosure, the light source module and the lens module are joined to each other to configure the light source assembly and the backlight assembly. As a result, the light uniformity improvement and the color uniformity improvement can be achieved, as described above.

The foregoing is illustrative of the present inventive concept and is not to be construed as limiting thereof. Although a few embodiments have been described, those skilled in the art will readily appreciate that many modifications are possible in the embodiments without materially departing from the novel teachings and advantages of the present invention. Accordingly, all such modifications are intended to be included within the scope of the present inventive concept. Therefore, it is to be understood that the foregoing is illustrative of the inventive concept presented herein and is not to be construed as limited to the specific embodiments disclosed, and that modifications to the disclosed embodiments, as well as other embodiments, are intended to be included within the scope of the disclosure.

What is claimed is:

1. A light source assembly, comprising:
a light source module capable of emitting light; and
a lens module positioned on the light source module,
wherein the lens module includes:
a light collecting lens configured to collect the light emitted from the light source module; and
a diffusion lens positioned on the light collecting lens, and including an inner curved surface on which light from the light collecting lens is incident and an outer curved surface through which the light incident on the inner curved surface exits the diffusion lens, and
wherein the light emitted from the light source module forms a light collecting region on the inner curved surface by passing through the light collecting lens.

2. The light source assembly of claim 1, wherein the lens module further includes a light scattering pattern that is formed on the inner curved surface and scatters the light incident in the inner curved surface.

3. The light source assembly of claim 2, wherein the light scattering pattern is positioned in a part of the inner curved surface where the light collecting region is formed.

4. The light source assembly of claim 1, wherein a focal point of the light collecting lens is positioned on the inner curved surface.

5. The light source assembly of claim 1, wherein the light collecting lens includes:
a first lens surface through which the light emitted from the light source unit enters the light collecting lens; and
a second lens surface through which the light exits the light collecting lens, and
a Fresnel lens surface is formed on at least one of the first lens surface and the second lens surface.

6. The light source assembly of claim 1, wherein the inner curved surface has a first oval surface shape in which a long axis is formed in a vertical direction, and the outer curved surface has a second oval surface shape in which a long axis is formed in a horizontal direction.

7. The light source assembly of claim 1, wherein the diffusion lens further includes a lens joining groove formed on the inner curved surface, and
the light collecting lens is inserted into and joined to the lens joining groove.

8. The light source assembly of claim 1, wherein the lens module further includes a support that extending from the bottom of the diffusion lens.

9. The light source assembly of claim 1, wherein the light source module includes:
a first light source emitting light of a first color;
a second light source emitting light of a second color;
a first resin formed on the first light source and including a fluorescent substance of a third color; and
a second resin formed on the first rein and the second light source.

10. The light source assembly of claim 9, wherein the first color is a blue color, the second color is a green color, and the third color is a red color.

11. A lens module collecting and diffusing light emitted from a light source module, comprising:
a light collecting lens collecting the light emitted from the light source module; and
a diffusion lens positioned on the light collecting lens, and including an inner curved surface that is configured to receive light from the light collecting lens and an outer curved surface through which the light exits the diffusion lens,
wherein there is a light collecting region on the inner curved surface where light from the light collecting lens is concentrated.

12. The lens module of claim 11, further comprising:
a light scattering pattern that is formed on the inner curved surface and scatters the light incident on the inner curved surface.

13. The lens module of claim 12, wherein the light scattering pattern is positioned in a part of the inner curved surface where the light collecting region is formed.

14. The lens module of claim 11, wherein a focal point of the light collecting lens is positioned on the inner curved surface.

15. The lens module of claim 11, wherein the light collecting lens includes:
a first lens surface in which the light emitted from the light source module is incident; and
a second lens surface to which the light incident in the first lens surface is emitted, and
a Fresnel lens surface is formed on at least one of the first lens surface and the second lens surface.

16. The lens module of claim 11, wherein the inner curved surface has a first oval surface shape in which a long axis is formed in a vertical plane direction, and the outer curved surface has a second oval surface shape in which a long axis is formed in a horizontal plane direction.

17. The lens module of claim 11, wherein the diffusion lens further includes a lens joining groove formed on the inner curved surface, and
the light collecting lens is inserted into and joined to the lens joining groove.

18. The lens module of claim 11, further comprising:
a support that extends from the bottom of the diffusion lens.

19. A backlight assembly, comprising:
a circuit substrate;
at least one light source assembly positioned on the circuit substrate; and
a receiving member receiving the circuit substrate,
wherein the light source assembly includes:
a light source module capable of emitting light; and
a lens module positioned on the light source module,
the lens module includes:
a light collecting lens configured to collect the light emitted from the light source module; and
a diffusion lens positioned on the light collecting lens, and including an inner curved surface on which light exiting the light collecting lens is incident and an outer curved surface where the light incident on the inner curved surface exits the diffusion lens, and
the light emitted from the light source module forms a light collecting region on the inner curved surface by passing through the light collecting lens.

20. The backlight assembly of claim 19, wherein the lens module further includes a light scattering pattern on the inner curved surface configured to scatter incident light.
